(19) United States
(12) Patent Application Publication
(10) Pub. No.: US 2017/0254254 A1
(43) Pub. Date: Sep. 7, 2017

(54) THERMOSTATIC VALVE HAVING A SLEEVE

(71) Applicant: VERNET, OLLAINVILLE (FR)

(72) Inventors: Aude POSTERNAK, PALAISEAU (FR); Thierry MARAUX, LES CLAYES SOUS BOIS (FR)

(73) Assignee: VERNET, Ollainville (FR)

(21) Appl. No.: 15/329,996

(22) PCT Filed: Jul. 28, 2015
(86) PCT No.: PCT/EP2015/067206

§ 371 Date: Jan. 27, 2017

(30) Foreign Application Priority Data
Jul. 29, 2014 (FR) 1457339

(51) Int. Cl. F01P 7/16; G05D 23/02

(52) U.S. Cl. CPC F01P 7/16; G05D 23/022

(57) ABSTRACT

A thermostatic valve including a body, defining a first pipe for fluid to flow therethrough, into which at least a second pipe and at least a third pipe transversely lead, a sleeve, movable inside the valve body to place at least one of the second and third pipes in communication with the first pipe, a thermostatic element, including a stationary portion and a movable portion movable by a change in the volume of a heat-expansible material in the thermostatic element and translatably connected to the sleeve, a housing for supporting the thermostatic element, rigidly connected to the stationary portion of the thermostatic element, immobilised inside the first pipe, and sealingly engages with the sleeve, and a sealing ring between the sleeve and valve body.

### PRIORITY AND CROSS REFERENCE TO RELATED APPLICATIONS

This application is the U.S. National Phase Application under 35 U.S.C. §371 of International Application No. PCT/EP2015/067206, filed Jul. 28, 2015, designating the U.S. and published as WO 2016/016210 A1 on Feb. 4, 2016, which claims the benefit of French Patent Application No. FR 1457339, filed Jul. 29, 2014. Any and all applications for which a foreign or a domestic priority is claimed is/are identified in the Application Data Sheet filed herewith and is/are hereby incorporated by reference in their entirety under 37 C.F.R. §1.57.

### BACKGROUND

The present invention relates to a thermostatic valve for a fluid circulation system, in particular for circulating a cooling fluid for cooling a combustion engine.

Valves provided with a regulating-control sleeve that is movement controlled by means of a thermostatic element typically equip cooling circuits that are associated with combustion engines having high engine cylinder capacity, in particular those used in trucks and certain motor vehicles, for which the flow rates of coolant fluid needed for their operation are higher than those encountered for combustion engines having lower engine cylinder capacity in which the thermostatic valves used have flap gates.

Indeed, the use of a sleeve generally makes it possible to have a obturator (gate, plug) that is said to be (pressure) balanced, that is to say, an obturator for which the difference in the pressures prevailing on both sides of the wall of the sleeve has a substantially zero value along the direction of movement of the sleeve by the thermostatic element, this direction corresponding in practice to the axial direction of the sleeve. Conversely, in a thermostatic valve having a flap gate, the latter generally extends in a plane that is perpendicular to the direction of movement of the flap gate by the thermostatic element, in such a manner that the difference in pressure prevailing on either side of the flap gate along this direction attains high values, in particular when the flow of fluid is cut off by the flap gate. The energy needed to dislodge such a flap gate from its seat is thus then often quite significant, and this is more so when the rate of flow of the fluid to be controlled is high and is running in the direction of closure of the flap gate.

### SUMMARY

To this end the invention relates to a thermostatic valve for a fluid circulation system, in particular for circulating a cooling fluid for cooling a combustion engine including a body, which delimits a first fluid flow pipe for fluid to flow therethrough, which extends along a longitudinal axis and into which lead transversely at least a second fluid flow pipe and at least a third fluid flow pipe; a flow control sleeve for regulating and controlling the flow of the fluid through the valve body, which defines a central axis that is parallel to the longitudinal axis and which is movable along this axis within the interior of the valve body so as to place at least one of the second and third pipes in communication with the first pipe; a thermostatic element, containing a heat-expansible material whose volume varies according to the temperature of the fluid flowing through the valve body, this element including a fixed or stationary portion that is stationary relative to the valve body and a movable portion, which is movable longitudinally in relation to the stationary portion as a result of the effect of a variation in the volume of the heat-expansible material and is connected in translational motion to the sleeve; a retaining housing for retaining the thermostatic element, which is integrally attached to the stationary portion of the thermostatic element, which is immobilised within the interior of the first pipe and which engages by means of sealed contact with the sleeve; and a sealing ring for sealing between the sleeve and valve body, which is arranged, fixedly with respect to the valve body, coaxially around the sleeve. In accordance with the invention the housing closes off one end of the first pipe, while the sealing ring is fixedly connected to the retaining housing for retaining the thermostatic element and comprises at least one flow-through opening for the fluid to flow through the body volume thereof.

### BRIEF DESCRIPTION OF THE DRAWINGS

The invention will be better understood and other advantages thereof will become more clearly apparent in the light of the description that follows of an embodiment of a thermostatic valve in accordance with the principle thereof, given only by way of an example and made in reference to the drawings in which:

FIG. 1 is a longitudinal cross section of a thermostatic valve in accordance with the invention, that is capable of regulating and controlling the circulation of cooling fluid in a combustion engine and represented in a flow-through or ‘by-pass’ configuration, for which the fluid flows normally in the cooling circuit;

FIG. 2 is a cross section that is analogous to the one in FIG. 1, in which the thermostatic valve is represented in another configuration, where the fluid flowing in the cooling circuit is diverted to a radiator in order to be cooled therein;

FIG. 3 is a perspective view of a sealing ring belonging to the thermostatic valve represented in the FIGS. 1 and 2; and

FIG. 4 is a view of a larger scale representation of the inset IV illustrated in FIG. 1.

### DETAILED DESCRIPTION

A thermostatic valve having a sleeve, such as that disclosed in the document U.S. Pat. No. 5,018,664, includes a valve body, which delimits a first fluid flow pipe for fluid to flow therethrough, into which a second fluid flow pipe and a third fluid flow pipe lead. This valve also includes a flow control sleeve for regulating and controlling the flow of the fluid through the valve body that is movable within the interior of the valve body so as to place at least one of the second pipe and the third pipe in communication with the first pipe. The valve also includes a thermostatic element, containing a heat-expansible (thermodilatable) material whose volume varies according to the temperature of the fluid flowing through the valve body, this element including a fixed or stationary portion that is stationary relative to the valve body and a movable portion, which is movable in relation to the stationary portion as a result of the effect of a variation in the volume of the heat-expansible material and is connected in translational motion to the sleeve. The fixed or stationary portion of the thermostatic element is attached on to a housing which is immobilised within the interior of the first pipe. This housing is configured so as to enable the flow there-through of the fluid flowing inside the first pipe. When the engine is cold, the cooling fluid in its entirety flows through the Bypass loop of the cooling circuit, that is to say, it passes through in the first and the second pipes. On the other hand, when the engine is overheating, the cooling fluid coming out of the engine is hot and the sleeve moves as a result of the effect of the expansion of the heat-expansible material. A portion or all of the cooling fluid is then diverted by the third pipe to a radiator, in order to be cooled therein.

Moreover, the valve also includes a sealing ring in order to ensure proper sealing between the sleeve and the valve body. This sealing ring is mounted tightly and press-fitted to be in contact with the inner wall of the main pipe so as to ensure an optimal sealing and to insulate the second pipe and the third pipe from one another. The mounting of this sealing ring within the interior of the main pipe is thus difficult and requires the provision of a stop shoulder at the level of the valve body.

In order to overcome this drawback, it is a technique known from the document WO-A-99/24701 to attach the sealing ring to the support housing for supporting the thermostatic element. In this document, the first fluid flow pipe for the fluid is a through pipe and a single pipe leads and opens out into this first pipe. When the fluid is very hot, the sleeve moves out of its seat in the valve body and comes to be bearing against the support housing for supporting the thermostatic element. The passage of the fluid flowing in the first pipe is closed off, on the one hand, by the sleeve, and on the other hand, by the sealing ring. In effect, this is designed so as to allow for the fluid to pass through only in a central manner, that is to say, its peripheral wall is solid or unperforated. However, the sealing ring is arranged in such a way that it forms an obturator that is not balanced, that is to say, that the difference in pressures prevailing on either side of its peripheral wall does not have a zero value. There is therefore the fear of the sealing ring possibly getting deformed, or even breaking when the valve is integrated into a cooling circuit of a heavy-duty engine, with a high rate of flow of the cooling fluid. This type of valve design is therefore not robust.

It is these drawbacks in particular that the invention is intended to remedy by offering a more robust thermostatic valve and for which there is moreover no problem with assembling of the sealing ring within the valve body.

Thanks to the invention, the assembly of the sealing ring within the interior of the valve body is facilitated since its mounting no longer requires press-fitting. In addition, there is no need to provide for a stop shoulder within the valve body. The sealing ring is indeed mounted, as one single composite unit, with the retaining housing for retaining the thermostatic element. In addition, the flow-through openings for the fluid to flow through that are arranged on its periphery serve the purpose of ensuring that it is not subjected to the pressure of the fluid flowing to the second pipe and that the only obturator of the valve is the sleeve, which is pressure balanced and adapted to the high fluid flow rates.

According to aspects of the invention that are advantageous but not mandatory, a thermostatic valve may incorporate one or more of the following characteristic features taken into consideration according to any technically permissible combination:

The sealing ring includes a first sealing annular member for sealing between the sleeve and the valve body and a second fastening annular member for fastening to the housing that is connected to the sealing annular member by means of tabs, the tabs defining there-between the fluid flow-through openings.

The second sealing annular member includes at least one boss, that is adapted for being lodged within a peripheral groove of the housing.

The first sealing annular member of the sealing ring is provided with an O-ring seal for sealing with the valve body.

The O-ring seal is lodged within a peripheral groove of the first sealing annular member.

The first sealing annular member of the sealing ring is provided with a lip seal in order to ensure sealing with the sleeve.

The lip seal is made of Teflon.

The sealing ring is made of sheet metal.

The lip seal is crimped within a sheet metal rim of the first sealing annular member of the sealing ring.

The sleeve is adapted so as to be tightly pressed in a sealed manner against the housing, in a manner such as to block the passage of fluid between the first pipe and the third pipe.

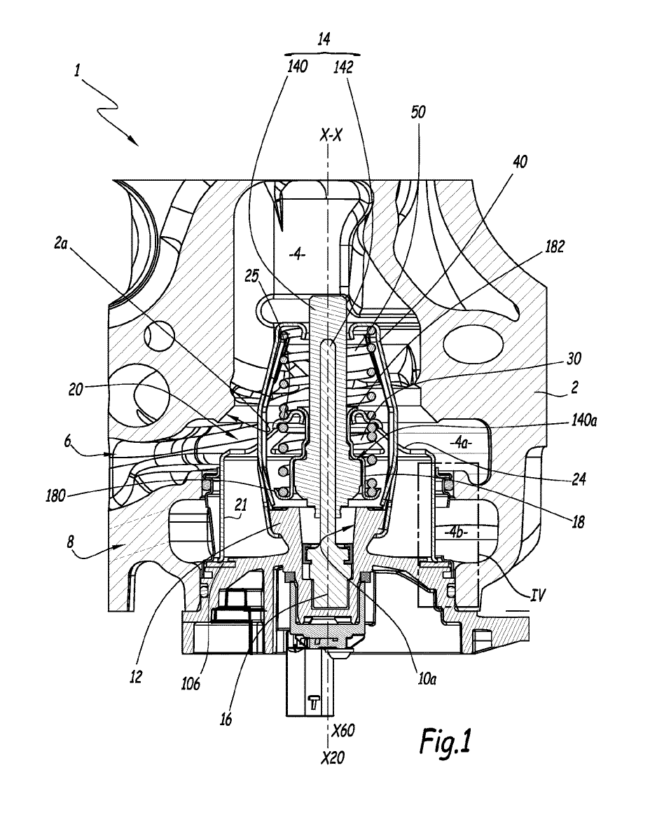

In FIGS. 1 to 4 is represented a thermostatic 1 that is capable of regulating and controlling the circulation of cooling fluid. Here, a fluid refers to a liquid, or even a two-phase mixture. The valve 1 is for example used in a cooling circuit for cooling a combustion engine of a vehicle.

The valve 1 includes a valve body 2 for routing of the fluid. This body 2 delimits a flow-through central pipe 4 for the fluid to flow therethrough. The central pipe 4 extends along a longitudinal axis X-X.

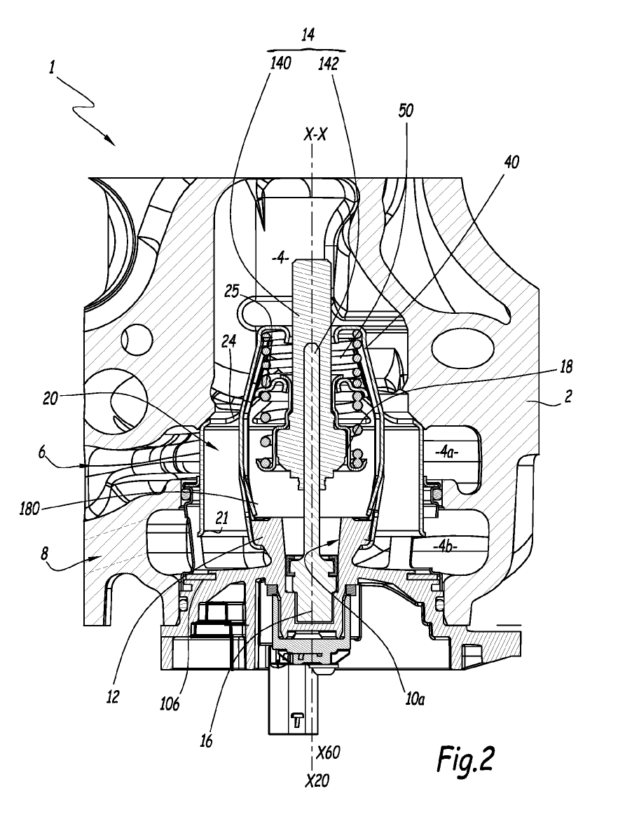

In the following sections of the description, the terms “high/up”, “low/down”, “top/upper” and “bottom/lower” should be interpreted in the configuration of FIGS. 1 and 2 and in relation to the longitudinal axis X-X. The central pipe 4 extends downwards to the bottom in FIGS. 1 and 2 and includes a first chamber 4A and a second chamber 4B, positioned below the chamber 4A. The body 2 delimits two other pipes 6 and 8, which open out transversely into the central pipe 4, respectively at the level of the chambers 4A and 4B. The pipes 6 and 8 thus do not open out at the same axial level relative to the axis X-X. The pipe 8 is not visible in the cross sectional plane shown in FIGS. 1 and 2, this is why it is schematically represented in dotted lines in these figures. In the example shown in the figures, a single pipe 6 leads and opens into the chamber 4A and a single pipe 8 leads and opens into the chamber 4B. However, a plurality of pipes may in practice lead and open into the same given chamber.

Thus the thermostatic valve 1 is a three-way valve. In the example considered, the fluid in-flow takes place by means of the pipe 4 and the fluid out-flow takes place by means of the pipes 6 and 8. However, it can be different depending on the mounting of the valve 1.

In addition, the thermostatic valve 1 comprises a support housing 10 for supporting the thermostatic element 14. This housing 10 closes off one end of the pipe 4, that is to say, the pipe 4 may be considered to be blind on account of the presence of the housing 10. The housing 10 is immobilised or locked in position in a sealed manner within the pipe 4 and delimits a receiving cavity 10a for receiving the thermostatic element 14. This cavity 10a is turned towards the top. The housing 10 also includes a top crown 12, which surrounds the cavity 10a.

The thermostatic element 14 includes a top cup 140, which has a geometry based on revolution around the axis X-X and which contains a heat-expansible material, not shown in the figures, such as a wax. The thermostatic element 14 also includes a lower rod 142, which extends along the axis X-X and which is immobilised or locked in position in relation to the housing 10. The rod 142 includes a top end that is engaged in a hole of the cup 140 and a lower end that protrudes out from the cup 140 extending downwards and which is integrally attached to a head 16. The head 16 cooperates with the housing 10 in a manner so as to ensure the rod 142 is locked in position relative to the latter. The head 16 is received in the receiving cavity 10a of the housing 10 and comes to be pressed against a bottom wall of the cavity 10a. The cup 140 is movable in translational motion along the axis X-X relative to the rod 142. More precisely, the cup 140 is movable as a result of the effect of expansion of the heat-expansible material contained within the interior thereof. The cup 140 is made out of a thermally conductive material, which is to say, that it heats up when in contact with the fluid with which it is steeped. In the configuration shown in FIG. 1, the flow of a hot fluid through the pipe 4 results in the moving of the cup 140 towards the top. Moreover, the cup 140 has an abutment shoulder 140a for abutting against a liner jacket 18. This shoulder 140a is turned towards the top, that is to say, that it reduces the transverse cross-section of the cup 140 towards the top.

The liner jacket 18 encircles the cup 140 in the lower part. It is therefore closely form-fitted to the outer surface of the cup 140. In particular, the liner jacket 18 takes the form of the shoulder 140a of the cup 140 in a manner such that the liner jacket 18 is driven jointly with the cup 140 in translational motion upon the heating of the heat-expansible material. The liner jacket 18 has a geometry based on revolution around the axis X-X and includes a lower edge 180 which is curved in the upward direction and which advantageously has a hook-shaped form. This hook-shaped form has a recess oriented in the upward direction. The liner jacket 18 comprises a top end 182, which is curved exteriorly relative to the axis X-X, that is to say which extends away from the cup 140.

The valve 1 also includes a sleeve 20 which, by definition, has an overall tubular form, centred on an axis X20 that is parallel to, or even combined with the axis X-X. The sleeve 20 is arranged within the interior of the main pipe 4 above the housing 10. It includes a cylindrical main body 21, that is centred on the axis X-X and whose wall is solid (unperforated) over its entire periphery. The lower axial end, that is to say the one oriented towards the housing 10, is adapted so as to come to be pressed in a sealed manner against the housing 10, in particular in order to block the passage between the pipes 4 and 8. The housing 10 therefore forms an axial support seat for the sleeve 20. More precisely, the housing 10 includes a sealing ring 106, having a disk shaped form, which is housed in a peripheral groove 104 of the housing 10. This sealing ring 106 is designed so as to be forcefully pressed by the sleeve 20 when the cooling fluid is cold, in a manner such as to block the passage between the pipes 4 and 8. The body 21 of the sleeve 20 is, at its top end, provided with an internal peripheral rim from which the arms 24 of the sleeve 20 rigidly extend in the direction of the axis X-X. The arms 24 do not extend radially relative to the axis X-X but rather in a manner that is oblique, and convergent relative to the axis X-X towards the top. At their free ends, the arms 24 are connected fixedly to each other by means of an annular crown member 25 belonging to the sleeve 20. This annular crown member 25 is substantially coaxial relative to the body 21. The annular crown member 25 is extended by means of a curled edge that has a hook shaped form whereof the recess is oriented downwards.

The sleeve 20 is adapted in order to regulate and control the flow of fluid through the valve body 2 and is movable along the axis X20 within the interior of the body 2 so as to place at least one of the pipes 6 and 8 in communication with the pipe 4. The curved end 182 of the liner jacket 18 caps the curled edge of the sleeve 20 in a manner such that the sleeve 20 is blocked in its movement directed upwards by the liner jacket 18.

A helical spring 30 extends axially between the liner jacket 18 and the sleeve 20. The spring 30 is centred on the axis X-X and comprises a bottom coil, which is housed in the recess formed at the lower end 180 of the liner jacket 18 and a top coil, positioned to be bearing against the annular crown member 25 of the sleeve 20.

The valve 1 also includes a stress absorbing calliper-bracket 40 for absorbing stresses, which is made of a rigid material, in particular metal. The calliper-bracket 40 includes the openings for passage of the arms 24 of the sleeve 20 and a top end part, which advantageously has a hook-shaped form, whose recess is oriented downwards.

Moreover, the calliper-bracket 40 includes a bottom end, that is adapted so as to engage mechanically with the crown 12 of the housing 10. In order to do this, this bottom end part is curved radially in the direction of the axis X-X and comes to bear against the bottom surface of the crown 12. In this way, the calliper-bracket 40 is attached by hooking into the housing 10, that is to say it is connected in a fixed manner to the latter.

A return spring 50 of the cup 140 of the thermostatic element 14 is arranged between the calliper-bracket 40 and the sleeve 20. More precisely, the return spring 50 is a helical spring centred on the axis X-X, which is positioned above the spring 30 and which comprises a bottom coil positioned to bear against the annular crown member 25 of the sleeve 20 in the downwards direction and a top coil 42, which is positioned to bear axially in the upwards direction against the bottom of the recess formed by the top end of the calliper-bracket 40. The calliper-bracket 40 is designed to support the work stresses generated by the spring 50 during its compression. The calliper-bracket 40 houses the springs 30 and 50, the thermostatic element 14 and the liner jacket 18.

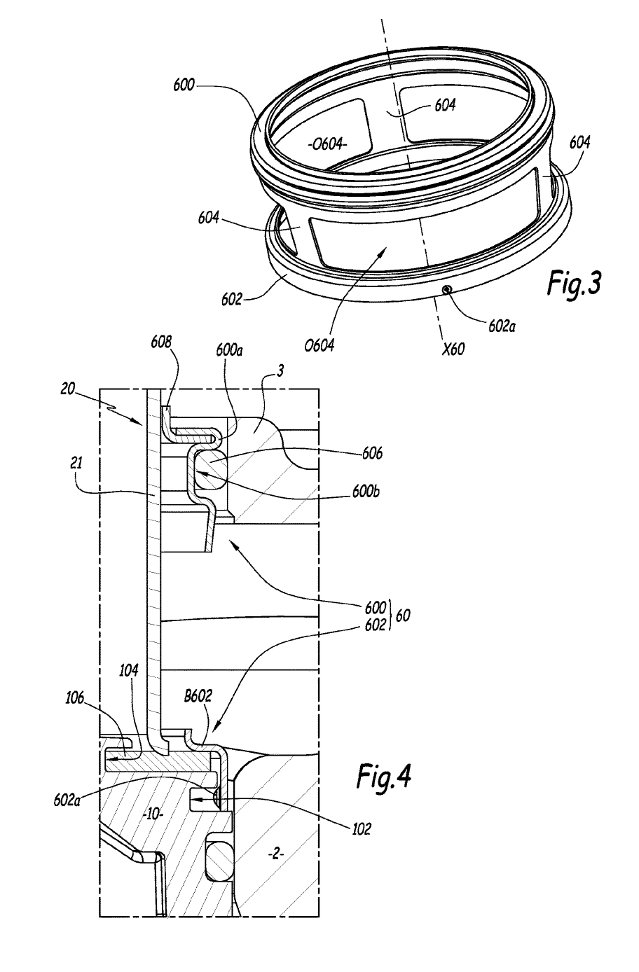

Finally the valve 1 also includes a sealing ring 60 to ensure proper sealing between the sleeve 20 and the valve body 2. This sealing ring 60 is more clearly visible in FIG. 3. It is coaxially disposed between the sleeve 60 and the wall of the pipe 4. More precisely, the sealing ring 60 is arranged in the flow-through chamber 4b for the fluid to flow through. It includes a top annular member 600 and a bottom annular member 602. The sealing ring 60 is centred on an axis X60, which, in a configuration mounted within the valve 1, is combined with the longitudinal axis X-X. The annular members 600 and 602 are connected to each other by means of three rigid rectilinear tabs 604, which extend parallelly to the axis X60. The annular members 600 and 602 are therefore fabricated as a single composite piece with the tabs 604. For example, the sealing ring 60 is fabricated by means of stamping of sheet metal.

The annular member 602 is connected fixedly to the housing 10. More precisely, the annular member 602 includes bosses 602a, which protrude radially to the axis X-X towards the interior and which engage with a peripheral groove 102 of the housing 10. This groove 102 is centred on the axis X-X. In the example, the bosses 602 are three in number and are distributed in a regular manner around the axis X60. The sealing ring 60 is thus “clipped” on to the housing 10 by insertion of the bosses 602a into the groove 102. The sealing ring 60 is therefore mounted as one single composite unit with the housing 10, which considerably facilitates the mounting in comparison with the assembly of the valve disclosed in the document U.S. Pat. No. 5,018,664. The tabs 604 define there-between flow-through openings O604 for the fluid to flow through. More precisely, each opening O204 is delimited between two successive tabs 604 and between the top annular member 600 and the bottom annular member 602. The openings O204 have a rectangular contour. The sealing ring 60 is therefore not completely solid over its entire periphery. The fluid can therefore flow through the sealing ring 60 right across the body volume thereof, that is to say, along a substantially radial direction relative to the axis X-X, so as to join the pipe 8. The sealing ring 60 thus does not serve the purpose of obturator, as is the case in the document WO-A-99/24701. Advantageously, the only obturator of the valve 1 is the sleeve 20, which is pressure balanced and therefore well adapted to be used for high fluid flow rates.

As can be seen in FIG. 4, the top annular member 600 of the sealing ring 60 is provided with a lip seal 608, which is positioned to bear in a peripheral manner against the exterior wall of the body 20 of the sleeve 21. The lip seal 608 is made of teflon and ensures proper sealing with respect to the sleeve 20. The lip seal 608 is crimped within a top rim 600a of the sealing annular member of the sealing ring 600, whose recess is oriented radially in the direction of the axis X-X, that is to say in a centripetal manner. The top annular member 600 is also provided with an O-ring seal 606, which is lodged within a peripheral groove 600b of the annular member 600. The O-ring seal 606 is forcefully jammed against the interior wall of a beading 3 of the body 2. It prevents the infiltration of fluid externally around the sealing ring 60.

Moreover, the bottom annular member 602 covers the exterior edge of the sealing ring 106. In effect, the bottom annular member 602 comprises a top edge B602 which is curved radially to the axis X60 towards the interior and which is positioned to bear against the top annular surface of the sealing ring 106, in such a manner that it maintains the sealing ring 106 in place within the interior of its housing 104.

In the example of a valve integrated into a cooling circuit for cooling a combustion engine, the pipe 6 routes a liquid in a cooling loop of the combustion engine that is not represented while the pipe 8 routes the liquid to a radiator that is not represented, in order for it to be cooled.

In FIG. 1, the sleeve 20 is found to be in a flow-through or ‘by-pass’ configuration, in which the engine is cold. In this configuration, the sleeve 20 closes off the pipe 8. The cooling fluid entering into the pipe 4 thus flows through in its entirety within the pipe 6, where it is redirected to the combustion engine. In other words, the liquid remains in the Bypass loop of the cooling circuit of the combustion engine. The liquid indeed does not need to be cooled since the engine is cold.

When the engine heats up, the cooling fluid flowing through the loop gets heated up and the cup 140 rises in temperature due to the heat exchange with the liquid. The heat-expansible material contained in the cup 140 expands, which consequently causes the cup 140 to move axially in the upward direction. The cup 140 in moving drives the liner jacket 18 by the presence of the shoulder 140a, which compresses the spring 30. The spring 30 presents a relatively high stiffness, to the extent that the moving of the liner jacket 18 also drives the movement of the sleeve 20 axially in the upward direction. The sleeve 20 is therefore connected in translational motion to the movable part 140 of the thermostatic element 14.

The movement of the sleeve 20 in the upward direction is brought about by the bearing of the top coil of the spring 30 on the annular crown member 25 of the sleeve 20. The movement of the sleeve 20 takes place against the resilient force of the spring 50. In other words, the spring 50 gets compressed during the moving of the sleeve 20 in the upward direction. Furthermore, the sleeve 20 rubs against the lip of the seal made of teflon 608 during its movement in a manner such that there is no liquid flowing around the sleeve 20.

When the sleeve 20 gets out of its seat, that is to say the housing 10, the liquid circulating within the interior of the sleeve 20 flows out into the chamber 4B and can escape through the pipe 8. More precisely, the liquid flowing out into chamber 4B escapes radially through the openings O604 of the sealing ring 60. The cooling fluid is thus partially diverted to the radiator in order to be cooled therein.

If the engine is not overheating, the sleeve 20 does not totally close off the pipe 6, that is to say that only a part of the liquid continues to circulate in the cooling loop of the combustion engine. This intermediate configuration where the pipes 6 and 8 are simultaneously open is not represented in the figures.

On the other hand, in the event of overheating of the combustion engine, the heat-expansible material contained within the interior of the cup 140 continues to expand and the sleeve 20 reaches a high position, in which it comes to bear in a sealed manner against a frustoconical wall 2a that is delimited within the body 2 and which diverges in the downward direction in relation to the axis X-X. In the high position, the sleeve 20 opens completely the 6 pipe, as shown in FIG. 2. In this position, the entirety of the liquid circulating in the pipe 4 traverses the sleeve 20 and escapes through the pipe 8, in the direction of the radiator.

When the liquid cools down, the heat-expansible material contained in the cup 140 does not exert any more expansion forces and the return spring 50 relaxes. The spring 50 thus exerts, on the annular crown member 25 of the sleeve 20, an elastic expansion force directed downwards, which returns the sleeve 20 elastically in the direction of the housing 10. The moving of the sleeve 20 consequently drives successively a compression and decompression of the spring 30. The latter thus then exerts on the lower end 180 of the liner jacket 18 a force directed downwards. This force is transmitted to the cup 140 by means of the shoulder 140a, which makes it possible to return the cup 140 elastically in the downwards direction, that is to say in the flow-through configuration represented in FIG. 1.

By way of a variant that is not represented, the sealing ring 60 can be attached to the housing 10 by any other appropriate means. For example, the sealing ring 60 may be welded or bonded on to the housing 10. The sealing ring 60 may also be screwed on to the housing 10 or attached by a locking means referred to as “bayonet”, with which a pin of the sealing ring 60 penetrates over at least a quarter turn into a curvilinear or angled channel of the housing 10.

According to another variant that is not represented, the sealing ring 60 is fabricated in plastic. In this case, the lip seal 608 is not maintained in position by means of crimping of sheet metal but by a ring nut connected on to the sealing ring.

Described here above is the conventional functioning of the thermostatic valve 1, for which the valve 1 is controlled solely by the temperature of the cooling fluid. Quite obviously, by way of a variant that is not represented, the thermostatic element 14 may be, in addition, driven electrically by connecting, via the housing 10, an electrical resistance, arranged within the interior of the rod 142, to an electric power source. This makes it possible in particular to force the cooling liquid to circulate in the radiator in a period of frost or freezing or even to anticipate an instance of overheating of the engine based on the load weight of the vehicle or the grade steepness.

The technical characteristic features of the variants and embodiments envisaged here above may be combined with each other in order to generate new embodiments of the invention.

1. A thermostatic valve for a fluid circulation system, including:
a valve body, which delimits a first fluid flow pipe for fluid to flow therethrough, which extends along a longitudinal axis and into which lead transversely at least a second fluid flow pipe and at least a third fluid flow pipe;
a flow control sleeve for regulating and controlling the flow of the fluid through the valve body, which defines a central axis that is parallel to the longitudinal axis and which is movable along this axis within the interior of the valve body so as to place at least one of the second and third fluid flow pipes in communication with the first pipe;
a thermostatic element, containing a heat-expansible material whose volume varies according to the temperature of the fluid flowing through the valve body, this element including a fixed or stationary portion that is stationary relative to the valve body and a movable portion, which is movable longitudinally in relation to the stationary portion as a result of the effect of a variation in the volume of the heat-expansible material and is connected in translational motion to the flow control sleeve;
a retaining housing for retaining the thermostatic element, which is integrally attached to the stationary portion of the thermostatic element, which is immobilised within the interior of the first pipe and which engages by means of sealed contact with the flow control sleeve; and
a sealing ring for sealing between the sleeve and valve body, which is arranged, fixedly with respect to the valve body, coaxially around the sleeve.
wherein the retaining housing closes off one end of the first fluid flow pipe, and wherein the sealing ring is fixedly connected to the retaining housing for retaining the thermostatic element and comprises at least one flow-through opening for the fluid to flow through the body volume thereof.

2. The thermostatic valve according to claim 1, wherein the sealing ring includes a first sealing annular member for sealing between the flow control sleeve and the valve body and a second fastening annular member for fastening to the retaining housing that is connected to the sealing annular member by means of tabs, the tabs defining there-between the fluid flow-through openings.

3. The thermostatic valve according to claim 2, wherein that the second sealing annular member (602) includes at least one boss, that is adapted for being lodged within a peripheral groove of the retaining housing.

4. The thermostatic valve according to claim 2, wherein the first sealing annular member of the sealing ring is provided with an O-ring seal (606) for sealing with the valve body.

5. The thermostatic valve according to claim 4, wherein the O-ring seal is lodged within a peripheral groove of the first sealing annular member.

6. The thermostatic valve according to claim 2, wherein the first annular member of the sealing ring is provided with a lip seal in order to ensure sealing with the flow control sleeve (20).

7. The thermostatic valve according to claim 6, wherein the lip seal is made of Teflon.

8. The thermostatic valve according to claim 1, wherein the sealing ring is made of sheet metal.

9. The thermostatic valve according to claim 6, wherein the sealing ring is made of sheet metal and wherein the lip seal is crimped within a sheet metal rim of the first sealing annular member of the sealing ring.

10. The thermostatic valve according to claim 1, wherein in flow control sleeve is adapted so as to be tightly pressed in a sealed manner against the retaining housing, in a manner such as to block the passage of fluid between the first fluid flow pipe and the third fluid flow pipe.
